(19) United States
(12) Patent Application Publication
(10) Pub. No.: US 2025/0329879 A1
(43) Pub. Date: Oct. 23, 2025

(54) ELECTROCHEMICAL DEVICE COMPRISING A SEPARATOR CONTAINING PVDF AND A HIGH-VISCOSITY OR HIGH-POLARITY ELECTROLYTIC COMPOSITION

(71) Applicant: Arkema France, Colombes (FR)

(72) Inventors: Marie BICHON, Pierre Benite (FR); Francois BEAUME, Pierre Benite (FR); Marie HUZAR-EA, Colombes (FR)

(21) Appl. No.: 18/868,206

(22) PCT Filed: May 23, 2023
(86) PCT No.: PCT/FR2023/050727

§ 371 Date: Nov. 22, 2024

(30) Foreign Application Priority Data
May 24, 2022 (FR) FR2204963

(51) Int. Cl. H01M 50/451; H01M 10/0525; H01M 10/0568; H01M 50/42; H01M 50/426; H01M 50/431

(52) U.S. Cl. CPC H01M 50/451; H01M 10/0525; H01M 10/0568; H01M 50/42; H01M 50/426; H01M 50/431

(57) ABSTRACT

The present invention relates to an electrochemical device comprising a separator and an electrolyte composition, characterized in that said separator comprises at least one coating comprising a polymer resin comprising monomer units of vinylidene fluoride and monomer units of formula R¹R²C═C(R³)C(O)R wherein the substituents R¹, R² and R³ are selected, independently of one another, from the group consisting of H and C₁-C₅ alkyl; R is selected from the group consisting of —NHC(CH₃)₂CH₂C(O)CH₃ or —OR′ with R′ selected from the group consisting of H and C₁-C₁ alkyl optionally substituted with one or more —OH groups or a five- or six-membered heterocycle comprising at least one nitrogen atom in its cyclic chain, and said electrolyte composition comprises a solvent and a lithium salt; said electrolyte composition having a viscosity greater than 2 cP measured at 20° C. and with a shear of 20 s⁻¹ or said solvent having a dipole moment greater than 2 Debye at 25° C.

### TECHNICAL FIELD

The present invention relates generally to the field of the storage of electrical energy in rechargeable storage batteries of Li-ion type. More specifically, the invention relates to an electrochemical device comprising a separator specifically adapted for high-viscosity or high-polarity electrolytes.

### TECHNOLOGICAL BACKGROUND OF THE PRESENT INVENTION

The market for separators for electrochemical devices is dominated by the use of polyolefins (for example Celgard® or Hipore®) produced by extrusion and/or drawing using dry or wet processes. The separators must simultaneously have small thicknesses, sufficient mechanical strength and temperature resistance, good electrochemical resistance to the voltages to which they are exposed, optimum affinity for the electrolyte and more generally must allow excellent ionic conductivity. Among the most advantageous alternatives to polyolefins, polymers exhibiting a better affinity with regard to standard electrolytes have been proposed, in order to reduce the internal resistances of the system, such as poly(methyl methacrylate) (PMMA), poly(vinylidene fluoride) (PVDF) and poly(vinylidene fluoride-co-hexafluoropropene) (P(VDF-co-HFP)). Another option consists in depositing a coating on one or two faces of the polyolefin separator. In the presence of the electrolyte, used in electrochemical devices, the separator must have good wettability in order to allow good efficiency of said device. However, separators based on polyolefins such as polypropylene or polyethylene have low wettability in the presence of a high-viscosity electrolyte or in the presence of a high-polarity electrolyte. The electrochemical device is then penalized by a long induction period in order to achieve its initial performance (negative impact on the construction of the cells and its productivity), then more generally shows poor performance both in terms of charging and in terms of discharging.

Poly(vinylidene fluoride) (PVDF) and its derivatives exhibit an advantage as polyolefin separator coating for their electrochemical stability and for their high dielectric constant, which promotes the dissociation of the ions and thus the conductivity. The crystallinity of P(VDF-co-HFP) copolymer (copolymer of vinylidene fluoride (VDF) and hexafluoropropylene (HFP)) is lower than that of PVDF. For this reason, the advantage of these P(VDF-co-HFP) copolymers is that they promote conductivity.

Document EP 2,528,141 describes a separator for a secondary battery comprising a porous substrate, an adhesive layer and a polar electrolyte. It was found that the wettability of the separator in the presence of a polar electrolyte was not sufficient.

There therefore remains a need to develop novel coatings for separators which are easy to implement and which exhibit a good compromise between dry adhesion, adhesion in the wet state, ionic conductivity and heat stability, while exhibiting good wettability to high-viscosity electrolytes or high-polarity electrolytes.

The aim of the invention is thus to overcome at least one of the drawbacks of the prior art, namely to propose a polymeric coating for a separator capable of promoting wettability with respect to high-viscosity electrolytes or high-polarity electrolytes.

### SUMMARY OF THE INVENTION

The present invention provides an electrochemical device comprising a separator and an electrolyte composition, characterized in that:
i) said separator comprises at least one coating comprising a polymer resin comprising monomer units of vinylidene fluoride and monomer units of formula R¹R²C═C(R³)C(O)R wherein the substituents R¹, R² and R³ are selected, independently of one another, from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl optionally substituted with one or more —OH groups or a five- or six-membered heterocycle comprising at least one nitrogen atom in its cyclic chain, and
ii) said electrolyte composition comprises a solvent and a lithium salt; said electrolyte composition having a viscosity greater than 2 cP measured at 20° C. and with a shear of 20 s⁻¹ or said solvent having a dipole moment greater than 2 Debye at 25° C.

The use of a specific coating based on a fluoro-acrylic polymer resin makes it possible to use an electrochemical device that is efficient and effective when the electrolyte composition used has a high viscosity or a high polarity. These performances, particularly in terms of wettability, are highly sought after. Indeed, the good wettability observed makes it possible to reduce the time necessary to achieve uniform distribution of the viscous or highly polar electrolyte within the separator and therefore within a lithium-ion battery. The improvement in wettability also makes it possible to increase the battery filling rates. This uniform distribution of the viscous or highly polar electrolyte compositions is not observed or difficult to achieve when the separator is based on polyolefins or fluoropolymers without acrylate or acrylic components.

According to a preferred embodiment, said electrolyte composition has a viscosity greater than 5 cP, preferably greater than 10 cP, in particular greater than 15 cP, measured at 20° C. and with a shear of 20 s⁻¹.

According to a preferred embodiment, said electrolyte composition has a viscosity less than 1000 cP, measured at 20° C. and with a shear of 20 s⁻¹.

According to a preferred embodiment, said solvent has a dipole moment greater than 2.5 Debye, preferably greater than 3.0 Debye, more preferentially greater than 3.5 Debye, in particular greater than 4.0 Debye at 25° C.

According to a preferred embodiment, said polymer resin is a copolymer comprising monomer units of vinylidene fluoride and monomer units of formula R¹R²C═C(R³)C(O)R or said polymer resin is a mixture of a fluoropolymer comprising monomer units of vinylidene fluoride and an acrylic polymer comprising monomer units of formula R¹R²C═C(R³)C(O)R wherein the substituents R¹, R² and R³ are selected, independently of one another, from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl optionally substituted with one or more —OH groups or a five- or six-membered heterocycle comprising at least one nitrogen atom in its cyclic chain.

According to a preferred embodiment, said polymer resin is a mixture of a fluoropolymer comprising monomer units of vinylidene fluoride and an acrylic polymer comprising monomer units of formula R¹R²C═C(R³)C(O)R wherein the substituents R¹, R² and R³ are selected, independently of one another, from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl optionally substituted with one or more —OH groups or a five- or six-membered heterocycle comprising at least one nitrogen atom in its cyclic chain; and said fluoropolymer is selected from the group of polyvinylidene fluoride homopolymers and copolymers based on polyvinylidene fluoride and on at least one comonomer compatible with vinylidene fluoride.

According to a preferred embodiment, said comonomers are selected from: vinyl fluoride, tetrafluoroethylene, hexafluoropropylene, trifluoropropenes, tetrafluoropropenes, hexafluoroisobutylene, perfluorobutylethylene, pentafluoropropenes, perfluoroalkyl vinyl ethers, bromotrifluoroethylene, chlorofluoroethylene, chlorotrifluoroethylene, chlorotrifluoropropene and ethylene.

According to a preferred embodiment, said fluoropolymer is a polyvinylidene fluoride-hexafluoropropylene copolymer having a percentage by weight of hexafluoropropylene monomer units of from 2% to 25%, preferably from 4% to 15% by weight relative to the weight of the copolymer.

According to a preferred embodiment, said fluoropolymer comprises monomer units bearing at least one of the following functions: carboxylic acid, carboxylic acid anhydride, carboxylic acid esters, epoxy groups, amide, hydroxyl, carbonyl, mercapto, sulfide, oxazoline, phenolic, ester, ether, siloxane, sulfonic, sulfuric, phosphoric or phosphonic.

According to a preferred embodiment, said acrylic polymer contains a monomer selected from the group consisting of methyl acrylate, ethyl acrylate, propyl acrylate, n-butyl acrylate, isobutyl acrylate, t-butyl acrylate, n-dodecyl acrylate, amyl acrylate, isoamyl acrylate, hexyl acrylate, 2-ethylhexyl acrylate, diacetone acrylamide, lauryl acrylate, n-octyl acrylate, hydroxybutyl acrylate, hydroxypropyl methacrylate, methyl acrylic acid, methyl methacrylate, ureido methacrylate and combinations thereof.

In a preferred embodiment, said coating comprises inorganic particles selected from the group consisting of: BaTiO₃, Pb(Zr,Ti)O₃, Pb₁₋ₓLaₓZr_{y}O₃ (0<x<1, 0<y<1), PBMg₃Nb_{2/3})₃, PbTiO₃, hafnia (HfO (HfO₂), SrTiO₃, SnO₂, CeO₂, MgO, NiO, CaO, ZnO, Y₂O₃, boehmite (γ-AlO(OH)), Al₂O₃, TiO₂, SiC, ZrO₂, boron silicate, BaSO₄, nanoclays, or mixtures thereof.

In a preferred embodiment, said device is selected from the group consisting of a Li-ion battery, a capacitor, an electric double layer capacitor, and a membrane electrode assembly (MEA) for a fuel cell; preferably a Li-ion battery.

According to a preferred embodiment, said device is a Li-ion secondary battery and also comprises an anode and a cathode.

### DETAILED DESCRIPTION OF THE PRESENT INVENTION

The present invention relates to an electrochemical device. Said electrochemical device comprises in particular a separator and an electrolyte composition which are described in more detail below. In addition to these two components, said electrochemical device comprises an anode and a cathode. Said separator according to the present invention is placed between the anode and the cathode of said electrochemical device. Preferably, the electrochemical device is selected from the group consisting of a Li-ion battery, a capacitor, an electric double layer capacitor, and a membrane electrode assembly (MEA) for a fuel cell. Preferably, said electrochemical device is a Li-ion secondary battery.

### Separator

The invention relates to an electrochemical device comprising a separator comprising at least one coating. Said coating contains a polymer resin comprising monomer units of vinylidene fluoride and monomer units of formula R¹R²C═C(R³)C(O)R wherein the substituents R¹, R² and R³ are selected, independently of one another, from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl optionally substituted with one or more —OH groups or a five- or six-membered heterocycle comprising at least one nitrogen atom in its cyclic chain. Thus, said polymer resin comprises a fluorine-containing portion and an acrylic portion. Said resin may be in the form of a mixture of a fluoropolymer and an acrylic polymer or in the form of a copolymer of fluorinated monomer units and acrylic monomer units.

Preferably, said polymer resin is present in non-crosslinked form in the separator coating. Said polymer resin may be linear or branched.

According to various implementations, said coating comprises the following characteristics, where appropriate combined. The contents indicated are expressed by weight, unless otherwise indicated. For all the indicated ranges, the limits are included unless otherwise indicated.

According to a preferred embodiment, said polymer resin is a copolymer comprising monomer units of vinylidene fluoride and monomer units of formula R¹R²C═C(R³)C(O)R. Said copolymer is described in greater detail below.

According to another embodiment, said polymer resin is a mixture of a fluoropolymer comprising monomer units of vinylidene fluoride and an acrylic polymer comprising monomer units of formula R¹R²C═C(R³)C(O)R wherein the substituents R¹, R² and R³ are selected, independently of one another, from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl optionally substituted with one or more —OH groups or a five- or six-membered heterocycle comprising at least one nitrogen atom in its cyclic chain. The fluoropolymer and the acrylic polymer are described below.

### i) Fluoropolymer

Said fluoropolymer is based on a vinylidene difluoride monomer and is generally referred to by the abbreviation PVBF.

According to one embodiment, the fluoropolymer is homopolymeric poly(vinylidene fluoride).

According to another embodiment, the fluoropolymer is a copolymer of vinylidene difluoride with at least one comonomer compatible with vinylidene difluoride. The comonomers compatible with vinylidene difluoride can be halogenated (fluorinated, chlorinated or brominated) or non-halogenated. Examples of appropriate fluorinated comonomers are: vinyl fluoride, tetrafluoroethylene, hexafluoropropylene, trifluoropropenes and in particular 3,3,3-trifluoropropene, tetrafluoropropenes and in particular 2,3,3,3-tetrafluoropropene or 1,3,3,3-tetrafluoropropene, hexafluoroisobutylene, perfluorobutylethylene, pentafluoropropenes and in particular 1,1,3,3,3-pentafluoropropene or 1,2,3,3,3-pentafluoropropene, perfluoroalkyl vinyl ethers and in particular those of general formula Rf—O—CF═CF₂, Rf being an alkyl group, preferably a C₁ to C₄ alkyl group (preferred examples being perfluoropropyl vinyl ether and perfluoromethyl vinyl ether).

The fluorinated comonomer can comprise a chlorine or bromine atom. It can in particular be selected from bromotrifluoroethylene, chlorofluoroethylene, chlorotrifluoroethylene and chlorotrifluoropropene. Chlorofluoroethylene can denote either 1-chloro-1-fluoroethylene or 1-chloro-2-fluoroethylene. The 1-chloro-1-fluoroethylene isomer is preferred. The chlorotrifluoropropene is preferably 1-chloro-3,3,3-trifluoropropene or 2-chloro-3,3,3-trifluoropropene.

The VDF copolymer can also comprise non-halogenated monomers, such as ethylene, and/or acrylic or methacrylic comonomers.

The fluoropolymer preferably contains at least 50 mol % of vinylidene difluoride.

According to one embodiment, the fluoropolymer is a copolymer of vinylidene fluoride (VDF) and of hexafluoropropylene (HFP) (P(VDF-HFP)), having a percentage by weight of hexafluoropropylene monomer units of from 2% to 30%, advantageously from 2% to 25%, preferably from 2% to 20%, preferably from 4% to 15%, by weight relative to the weight of the copolymer.

According to one embodiment, the fluoropolymer is a copolymer of vinylidene fluoride and of tetrafluoroethylene (TFE).

According to one embodiment, the fluoropolymer is a copolymer of vinylidene fluoride and of chlorotrifluoroethylene (CTFE).

According to one embodiment, the fluoropolymer is a VDF-TFE-HFP terpolymer.

According to one embodiment, the fluoropolymer is a VDF-TrFE-TFE terpolymer (TrFE being trifluoroethylene). In these terpolymers, the content by weight of VDF is at least 10%, the comonomers being present in variable proportions.

According to one embodiment, the fluoropolymer comprises monomer units bearing at least one of the following functions: carboxylic acid, carboxylic acid anhydride, carboxylic acid esters, epoxy groups (such as glycidyl), amide, hydroxyl, carbonyl, mercapto, sulfide, oxazoline, phenolic, ester, ether, siloxane, sulfonic, sulfuric, phosphoric or phosphonic. The function is introduced by a chemical reaction which can be grafting or a copolymerization of the fluorinated monomer with a monomer bearing at least one of said functional groups and a vinyl function capable of copolymerizing with the fluorinated monomer, according to techniques well known to a person skilled in the art.

According to one embodiment, the functional group bears a carboxylic acid function which is a group of (meth)acrylic acid type selected from acrylic acid, methacrylic acid, hydroxyethyl (meth)acrylate, hydroxypropyl (meth)acrylate and hydroxyethylhexyl (meth)acrylate.

According to one embodiment, the units bearing the carboxylic acid function additionally comprise a heteroatom selected from oxygen, sulfur, nitrogen and phosphorus.

According to one embodiment, the functionality is introduced via the transfer agent used during the synthesis process. The transfer agent is a polymer with a molar mass of less than or equal to 20 000 g/mol and which bears functional groups selected from the following groups: carboxylic acid, carboxylic acid anhydride, carboxylic acid ester, epoxy (such as glycidyl), amide, hydroxyl, carbonyl, mercapto, sulfide, oxazoline, phenolic, ester, ether, siloxane, sulfonic, sulfuric, phosphoric or phosphonic. An example of transfer agent of this type is acrylic acid oligomers.

The content of functional groups of said fluoropolymer is at least 0.01 mol %, preferably at least 0.1 mol %, and at most 15 mol %, preferably at most 10 mol %.

More particularly, the transfer agent bearing the functionality is incorporated into said fluoropolymer at the chain end. Thus, said fluoropolymer may comprise end groups consisting of said transfer agent. In particular, the transfer agent is a polymer having a molar mass of less than or equal to 20 000 g/mol and bearing functional groups selected from the group consisting of carboxylic acid or carboxylic acid ester.

The fluoropolymer preferably has a high molecular weight. The term “high molecular weight”, as used here, is understood to mean a fluoropolymer having a melt viscosity of greater than 100 Pa·s, preferably of greater than 500 Pa·s, more preferably of greater than 1000 Pa·s, according to the ASTM D-3835 method, measured at 232° C. and 100 sec⁻¹.

According to one embodiment, the fluoropolymer bearing functional groups can undergo crosslinking either by self-condensation of its functional groups or by reaction with a catalyst and/or a crosslinking agent, such as melamine resins, epoxy resins and the like, and also known crosslinking agents of low molecular weight, such as di- or higher polyisocyanates, polyaziridines, polycarbodiimides, polyoxazolines, dialdehydes, such as glyoxal, acetoacetates, malonates, acetals, thiols and acrylates which are di- and trifunctional, cycloaliphatic epoxy molecules, organosilanes, such as epoxysilanes and aminosilanes, carbamates, diamines and triamines, inorganic chelating agents, such as certain zinc and zirconium salts, titaniums, glycourils and other aminoplasts. In certain cases, functional groups originating from other polymerization ingredients, such as surfactants, initiators, seed particles, can be involved in the crosslinking reaction. When two or more functional groups are involved in the crosslinking process, the pairs of complementary reactive groups are, for example, hydroxyl-isocyanate, acid-epoxy, amine-epoxy, hydroxyl-melamine, acetoacetate-acid. The acrylate and/or methacrylate monomers not containing functional groups capable of participating in crosslinking reactions after the polymerization should preferably represent 70% or more by weight of the total mixture of monomers and more preferably should be greater than 90% by weight. According to one embodiment, the fluoropolymer comprises a crosslinking agent selected from the group consisting of isocyanates, diamines, adipic acid, dihydrazides and their combinations.

According to some embodiments, the PVDF homopolymer and the VDF copolymers are composed of biobased VDF. The term “biobased” means “derived from biomass”. This makes it possible to improve the ecological footprint of the separator. Biobased VDF can be characterized by a content of renewable carbon, that is to say of carbon of natural origin originating from a biomaterial or from biomass, of at least 1 atom %, as determined by the content of ¹⁴C according to Standard NF EN 16640. The term “renewable carbon” indicates that the carbon is of natural origin and originates from a biomaterial (or from biomass), as indicated below. According to some embodiments, the biocarbon content of the VDF can be greater than 5%, preferably greater than 10%, preferably greater than 25%, preferably greater than or equal to 33%, preferably greater than 50%, preferably greater than or equal to 66%, preferably greater than 75%, preferably greater than 90%, preferably greater than 95%, preferably greater than 98%, preferably greater than 99%, advantageously equal to 100%.

The homopolymeric fluoropolymers and the VDF copolymers used in the invention can be obtained by known polymerization methods such as emulsion or suspension polymerization.

According to one embodiment, they are prepared by an emulsion polymerization process in the absence of a fluorinated surface-active agent.

The polymerization of the PVDF results in a latex generally having a solids content of from 10% to 60% by weight, preferably from 10% to 50%, and having a weight-average particle size of less than 1 micrometer, preferably of less than 1000 nm, preferably of less than 800 nm and more preferably of less than 600 nm. The weight-average size of the particles is generally at least 20 nm, preferably at least 50 nm, and advantageously the average size is within the range from 100 to 400 nm. The polymer particles can form agglomerates, the weight-average size of which is from 1 to 30 micrometers and preferably from 2 to 20 micrometers. The agglomerates can break up into discrete particles during the formulation and the application to a substrate.

### ii) Acrylic Polymer

As mentioned above, said acrylic polymer comprises monomer units of formula R¹R²C═C(R³)C(O)R wherein the substituents R¹, R² and R³ are selected, independently of one another, from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl optionally substituted with one or more —OH groups or a five- or ten-membered heterocycle comprising at least one nitrogen atom in its cyclic chain. Said heterocycle can be saturated or unsaturated or aromatic. Said heterocycle can be monocyclic or bicyclic. Said heterocycle can be a pyrrole, pyrrolidine, pyridine, piperidine, pyrimidine, pyrazine, 1,4-dihydropyridine, indole, oxindole, isatin, quinoline, isoquinoline, quinazoline, imidazoline, pyrazolidine, 2-pyrrolidone, delta-lactam, succinimide, 2-imidazolidinone or 4-imidazolidinone ring. Said heterocycle may be substituted with one or more C₁-C₅ alkyl groups. As mentioned above, the C₁-C₁₈ alkyl is optionally substituted with said heterocycle. The latter can be bonded to the chain via the nitrogen atom or any other atoms forming the heterocycle. Preferably, the heterocycle is 2-pyrrolidone, delta-lactam, succinimide, 2-imidazolidinone or 4-imidazolidinone.

Preferably, said acrylic polymer is based on an alkyl acrylate monomer of formula R¹R²C═C(R³)C(O)R wherein the substituents R¹, R² and R³ are selected, independently of one another, from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl optionally substituted with one or more —OH groups or a five- or ten-membered heterocycle comprising at least one nitrogen atom in its cyclic chain.

Preferably, the heterocycle is as defined above; in particular, the heterocycle is 2-pyrrolidone, delta-lactam, succinimide, 2-imidazolidinone or 4-imidazolidinone.

According to one embodiment, the substituent R′ is selected from the group consisting of H, methyl, ethyl, propyl, n-butyl, isobutyl, t-butyl, n-dodecyl, amyl, isoamyl, hexyl, 2-ethylhexyl, lauryl, n-octyl, hydroxybutyl, hydroxypropyl, ethyl substituted with a ureido, hydroxyethyl, hydroxypropyl, hydroxybutyl group.

In particular, said acrylic polymer is based on an alkyl acrylate monomer of formula R¹R²C═C(R³)C(O)R wherein the substituents R¹ and R² are H; R³ is H or CH₃; R is —OR′ with R′ selected from the group consisting of H, methyl, ethyl, propyl, n-butyl, isobutyl, t-butyl, hydroxypropyl, hydroxybutyl, 2-pyrrolidone, deltalactam, succinimide, 2-imidazolidinone or 4-imidazolidinone.

Thus, the alkyl acrylate may be methyl acrylate, ethyl acrylate, propyl acrylate, n-butyl acrylate, isobutyl acrylate, t-butyl acrylate, n-dodecyl acrylate, amyl acrylate, isoamyl acrylate, hexyl acrylate, 2-ethylhexyl acrylate, diacetone acrylamide, lauryl acrylate, n-octyl acrylate, hydroxypropyl methacrylate, hydroxybutyl acrylate, methacrylic acid, methyl methacrylate, ureido methacrylate. Among these, alkyl acrylates with an alkyl group having from 1 to 8 carbon atoms are preferred, and alkyl acrylates with an alkyl group having from 1 to 5 carbon atoms are more preferable. These compounds can be used alone or as a mixture of two or more.

The term “acrylate” here comprises acrylates and methacrylates.

The optional ethylenically unsaturated compound which is copolymerizable with the alkyl acrylate and the alkyl methacrylate comprises:
(A) an alkenyl compound containing a functional group, and
(B) an alkenyl compound without a functional group.

The alkenyl compound (A) containing a functional group comprises, for example, α,β-unsaturated carboxylic acids, such as acrylic acid, methacrylic acid, fumaric acid, crotonic acid, itaconic acid and the like; vinyl ester compounds, such as vinyl acetate, vinyl neodecanoate and the like; amide compounds, such as acrylamide, methacrylamide, N-methylacrylamide, N-methylmethacrylamide, N-methylolacrylamide, N-methylolmethacrylamide, N-alkylacrylamide, N-alkylmethacrylamide, N,N-dialkylacrylamide, N,N-dialkylmethacrylamide, diacetone acrylamide and the like; acrylic acid esters, such as 2-hydroxyethyl acrylate, N-dialkylaminoethyl acrylate, glycidyl acrylate, n-dodecyl acrylate, fluoroalkyl acrylate and the like; methacrylic acid esters, such as dialkylaminoethyl methacrylate, fluoroalkyl methacrylate, 2-hydroxyethyl methacrylate, n-octyl methacrylate, t-butyl methacrylate, glycidyl methacrylate, ethylene glycol dimethacrylate and the like; maleic anhydride, and alkenyl glycidyl ether compounds, such as allyl glycidyl ether and the like. Among these, preference is given to acrylic acid, methacrylic acid, itaconic acid, fumaric acid, N-methylolacrylamide, N-methylolmethacrylamide, diacetone acrylamide, 2-hydroxyethyl acrylate, 2-hydroxyethyl methacrylate and allyl glycidyl ether. These compounds can be used alone or as a mixture of two or more.

The alkenyl compound without a functional group (B) comprises, for example, conjugated dienes, such as 1,3-butadiene, isoprene and the like; divinyl hydrocarbon compounds, such as divinylbenzene and the like; and alkenyl cyanides, such as acrylonitrile, methacrylonitrile and the like. Among these, 1,3-butadiene and acrylonitrile are the preferred ones. These compounds can be used alone or as a mixture of two or more.

It is preferable for the functional alkenyl compound (A) to be used in a proportion of less than 50% by weight, with respect to the weight of the mixture of monomers, and for the alkenyl compound without a functional group (B) to be used in a proportion of less than 30% by weight, with respect to the weight of the mixture of monomers.

The acrylic polymer used in the invention can be obtained by polymerization of the alkyl acrylate monomer according to known polymerization methods such as emulsion or suspension polymerization.

iii) Mixture of a Fluoropolymer and an Acrylic Polymer

Said polymer resin can be prepared by various processes.

According to a first embodiment, the fluoropolymer and the acrylic polymer are obtained by known polymerization methods such as emulsion or suspension polymerization, independently of one another. The two polymers are then mixed in the powder or latex state during the preparation of an aqueous formulation or in the presence of an organic solvent intended for the use of the separator.

Alternatively, according to another preferred embodiment, the polymer resin is synthesized by emulsion polymerization of acrylate/methacrylate monomers using a latex of said fluoropolymer as seed, thereby giving a fluoro-acrylic polymer composition wherein at least one part of the fluoropolymer and of the acrylic polymer are intimately mixed.

The fluoro-acrylic polymer resin is an aqueous dispersion obtained by emulsion polymerization of from 5 to 100, preferably 5-95 parts by weight of a mixture of monomers having at least one monomer selected from the group consisting of alkyl acrylates the alkyl groups of which have 1-18 carbon atoms and alkyl methacrylates the alkyl groups of which have 1-18 carbon atoms and optionally an ethylenically unsaturated compound copolymerizable with alkyl acrylates and alkyl methacrylates, in an aqueous medium in the presence of 100 parts by weight of particles of a vinylidene fluoride polymer as defined above. The PVDF particles serve as seed for the polymerization of the acrylic monomers. The PVDF particles may be added to the polymerization system in any state so long as they are dispersed in an aqueous medium in the form of particles. Since the vinylidene fluoride polymer is generally produced in the form of an aqueous dispersion, it is practical for the aqueous dispersion such as that produced to be used as seed particles. The diameters of the vinylidene fluoride particles are within the range of preferably from 0.04 to 2.9 micrometers. In a preferred embodiment, the diameter of the polymer particles is preferably from 50 nm to 700 nm. The product of the polymerization is a latex which may be used in this form, generally after filtering off the solid byproducts of the polymerization process. For the use in the form of a latex, the latex may be stabilized by the addition of a surface-active agent, which may be identical to or different from the surface-active agent present during the polymerization (where appropriate). This surfactant added later may, for example, be an ionic or nonionic surfactant.

The PVDF particles used as seed may have a homogeneous or heterogeneous nature or a gradient between the core and the surface of the particles, in terms of composition (content of HFP comonomer, for example) and/or of molecular weight.

In the fluoro-acrylic polymer resin, the PVDF/acrylic polymer mass ratio varies from 95/5 to 5/95, preferably from 75/25 to 25/75, advantageously from 60/40 to 40/60.

In the fluoro-acrylic polymer resin, the average diameter of the particles is from 0.05-3 μm, preferably from 0.05-1 μm, more preferentially from 0.1-1 μm. In this embodiment, the fluoro-acrylic polymer resin is characterized by intimate mixing of the fluoropolymer chains and the acrylic polymer chains in at least a part of the particle.

### iv) VDF/AA Copolymer

Alternatively, said polymer resin may be a copolymer comprising vinylidene fluoride monomer units and monomer units (A) of formula R¹R²C═C(R³)C(O)OR wherein the substituents R¹, R² and R³ are selected, independently of one another, from the group consisting of H and C₁-C₃ alkyl; R is selected from the group consisting of H and C₁-C₅ alkyl optionally substituted with at least one —OH group.

Preferably, the monomer units A are of formula R¹R²C═C(R³)C(O)OR wherein the substituents R¹, R² and R³ are selected, independently of one another, from the group consisting of H and CH₃; R is selected from the group consisting of H, hydroxypropyl and hydroxyethyl or a mixture thereof. The term hydroxypropyl corresponds to —CH₂CH(OH)CH₃. The term hydroxyethyl corresponds to —CH(CH₃)CH₂OH.

Preferably, the monomer units A of formula R¹R²C═C(R³)C(O)OR are distributed along the polymer chain mainly formed by vinylidene fluoride monomer units. In this embodiment, said polymer resin comprises at least 0.01 mol %, advantageously at least 0.02 mol %, preferably at least 0.03 mol %, in particular 0.04 mol % of monomer units A. Preferably, said polymer resin comprises at most 5 mol %, advantageously at most 4 mol %, preferably at most 2 mol %, in particular at most 1 mol %, more particularly at most 0.75 mol % of monomer units A.

In this embodiment, said polymer resin may also comprise, in addition to the vinylidene fluoride monomer units and monomer units A, monomer units derived from one or more fluorinated comonomers B. Said comonomer B is preferably an ethylenically unsaturated comonomer comprising at least one fluorine atom. Nonlimiting examples of comonomer B include: C₂-C₈ perfluoroolefins such as tetrafluoroethylene; perfluoroalkylethylene of formula CH₂═CHR¹ wherein R¹ is a C₂-C₆ perfluoroalkyl; chloro- or bromo- or iodo-C₂-C₆ fluoroolefin such as chlorotrifluoroethylene; perfluoroalkylvinyl ethers of formula CF₂═CFOR² wherein R² is C₁-C₆ perfluoroalkyl, C₁-C₁₂ alkoxy, C₁-C₁₂ perfluoroalkoxy; perfluoroalkylvinyl ether of formula CF₂═CFOCF₂OR³ wherein R³ is C₁-C₆ perfluoroalkyl or C₁-C₆ perfluoroalkoxy; perfluorooxyalkylvinyl ether of formula CF₂═CFOR⁴ wherein R⁴ is C₁-C₁₂ alkyl, C₁-C₁₂ perfluoroalkyl, C₁-C₁₂ perfluoroether and R⁴ bears a carboxylic acid or sulfonic acid group or a salt thereof.

### V) Inorganic Particles and Optional Additives

The coating for a separator according to the invention can contain, in addition to said polymer resin described, inorganic particles which serve to form micropores in the coating (the interstices between inorganic particles). The addition of inorganic particles can also contribute to the resistance to heat or improve the wettability. According to one embodiment, said coating comprises from 50% to 99% by weight of inorganic particles, with respect to the weight of the coating. These inorganic particles must be electrochemically stable (not subject to oxidation and/or to reduction within the range of voltages which are used). In addition, the pulverulent inorganic materials preferably have a high ionic conductivity. Low-density materials are preferred to materials of higher density, since the weight of the battery produced can be reduced. The dielectric constant is preferably equal to or greater than 5. According to one embodiment, said inorganic particles are selected from the group consisting of: BaTiO₃, Pb(Zr,Ti)O₃, Pb₁₋ₓLaₓZr_{y}O₃ (0<x<1, 0<y<1), PBMg₃Nb_{2/3})₃, PbTiO₃, hafnia (HfO (HfO₂)), SrTiO₃, SnO₂, CeO₂, MgO, NiO, CaO, ZnO, Y₂O₃, boehmite (γ-AlO(OH)), Al₂O₃, TiO₂, SiC, ZrO₂, boron silicate, BaSO₄, nanoclays and mixtures thereof. In this case, the ratio of the solids of the polymer to the inorganic particles is from 0.5 to 40 parts by weight of solids of said polymer resin per 60 to 99.5 parts by weight of inorganic particles. Advantageously, the ratio of the solids of the polymer to the inorganic particles is from 0.5 to 35 per 65 to 99.5 parts by weight of inorganic particles. Preferably, the ratio of the solids of the polymer to the inorganic particles is from 0.5 to 30 per 70 to 99.5 parts by weight of inorganic particles. The coating for a separator of the invention may optionally comprise from 0 to 15% by weight, based on the polymer, and preferably 0.1 to 10% by weight of additives, selected from thickeners, pH-adjusting agents, anti-settling agents, surfactants, foaming agents, fillers, antifoam agents and fugitive or non-fugitive adhesion promoters.

Said separator according to the present invention comprises a coating, as described above, optionally placed on one or both faces of a porous support. In this case, the coating is used to coat the support of a separator, on at least one face, in the form of a monolayer or of multilayers. There is no specific limitation on the choice of the support which is coated with the coating of the invention, as long as it is a porous substrate having pores. Said support may comprise a single layer or several distinct layers. When it comprises several layers, the coating as described in the present invention is placed on the external face of the support, that is to say on the face which will be first in contact with the electrolyte composition. Advantageously, the application of the coating according to the invention to the support is done via the aqueous route or via the solvent route. The porous substrate can take the form of a membrane or of a fibrous fabric. When the porous substrate is fibrous, it can be a non-woven web forming a porous web, such as a web obtained by direct spinning or melt blowing (of spun bond or melt blown type) or electrospinning. Examples of porous substrates of use in the invention as support comprise, without being limited thereto: polyolefins, polyethylene terephthalate, polybutylene terephthalate, polyester, polyacetal, polyamide, polycarbonate, polyimide, polyether ether ketone, polyether sulfone, poly(phenylene oxide), poly(phenylene sulfide), polyethylene naphthalate or mixtures thereof. However, other engineering plastics which are resistant to heat can be used, without specific limitation. Non-woven materials made of natural or synthetic materials can also be used as substrate of the separator. The porous substrate generally has a thickness of 1 to 50 μm, and is typically membranes obtained by extrusion and drawing (wet or dry processes) or cast non-wovens. The porous substrate preferably has a porosity of between 5% and 95%. The average size of the pores (diameter) is preferably of between 0.001 and 50 μm, more preferably between 0.01 and 10 μm.

According to an alternative embodiment, said separator does not comprise a porous support. In this case, said separator consists of the coating according to the present invention comprising said polymer resin; said coating is deposited directly on the cathode or on the anode of said electrochemical device. The absence of porous support makes it possible to limit the production costs of the electrochemical device and the dimensions of the latter. In this case, said coating replaces the porous support. In this embodiment, said polymer resin preferably has a porosity of 5 to 95%. The average size of the pores of said polymer resin is preferably between 0.001 and 50 μm, more preferably between 0.01 and 10 μm.

According to another alternative embodiment, said separator does not comprise a porous support and said separator is in the form of a gel. Said separator is as described in the present application. Said separator is formed into a gel by the usual techniques, such as solvent cast or extrusion.

The coating for a separator of the invention exhibits an excellent compromise of properties for the separator coating application: a good dry adhesion and adhesion in the wet state, a good resistance to electrolyte solvent(s) characterized by a good preserved integrity and moderate swelling, and a good Gurley permeability. The coating for a separator of the invention also makes it possible to improve the wettability of the separator when the electrolyte composition has a high viscosity or a high polarity, as is explained in the examples below.

### Electrolyte Composition

According to the present invention, said electrochemical device comprises an electrolyte composition. The electrolyte composition impregnates the separator to allow impregnation of lithium ions within the device. As mentioned above, the electrolyte composition comprises a solvent and a lithium salt. The solvent may be one of the solvents mentioned below or a mixture thereof. According to a first embodiment, said solvent used in the electrolyte composition has a high polarity. The term “polarity” refers to the dipole moment at 25° C. of the solvent used in the electrolyte composition.

In another embodiment, the electrolyte composition has a high viscosity. The viscosity is measured with a Brookfield Metek DV2T viscometer at 20° C. and a shear of 20 s⁻¹.

Preferably, said electrolyte composition has a viscosity greater than 2.0 cP measured according to the method described above.

In a preferred embodiment, said electrolyte composition may also have a viscosity greater than 3 cP, greater than 4 cP, greater than 5 cP, greater than 6 cP, greater than 7 cP, greater than 8 cP, greater than 9 cP, greater than 10 cP, greater than 11 cP, greater than 12 cP, greater than 13 cP, greater than 14 cP, greater than 15 cP, greater than 16 cP, greater than 17 cP, greater than 18 cP, greater than 19 cP, greater than 20 cP, greater than 21 cP, greater than 22 cP, greater than 23 cP, greater than 24 cP, greater than 25 cP, greater than 26 cP, greater than 27 cP, greater than 28 cP, greater than 29 cP or greater than 30 cP.

According to a preferred embodiment, said electrolyte composition may also have a viscosity of between 2 cP and 600 cP, advantageously between 5 and 500 cP, preferably between 10 and 450 cP, more preferentially between 15 and 400 cP, in particular between 20 and 350 cP, more particularly between 25 and 300 cP, preferably between 25 and 250 cP, advantageously preferably between 30 and 200 cP.

The lithium salt may be present in the electrolyte composition at highly variable concentrations. A high concentration of lithium salt will promote a high viscosity of the electrolyte composition. For example, the lithium salt may be present in the electrolyte composition at a concentration of between 0.01 and 20 mol·l⁻¹, advantageously between 0.01 and 15 mol·l⁻¹, preferably between 0.01 and 10 mol·l⁻¹. A high concentration of lithium salt in said electrolyte composition will promote the performance of the electrochemical device in terms of capacity.

Preferably, said electrolyte composition has a viscosity of less than 1000 cP measured according to the method described above, advantageously less than 900 cP, preferably less than 800 cP, more preferentially less than 700 cP, in particular less than 600 cP.

For example, said solvent may be of formula (Ia), (Ib), (Ic), (Id), (Ie), (If), (Ig), (Ih), (Ii), (Ij), (Ik), (Il), (Im), (In), (Io), (Ip), (Iq), (Ir), (Is), (It), (Iu), (Iv), (Iw), (Ix), (Iy) or (Iz):

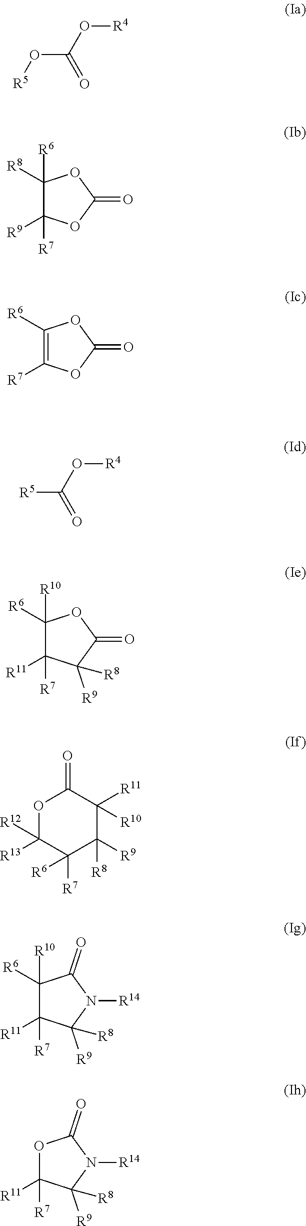

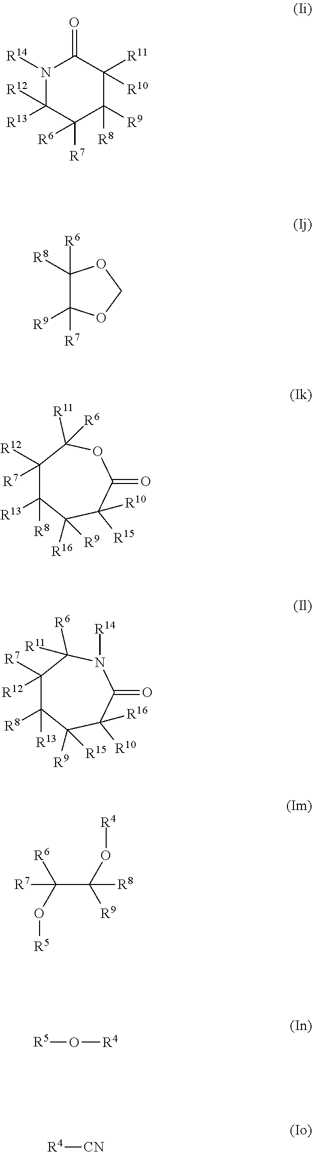

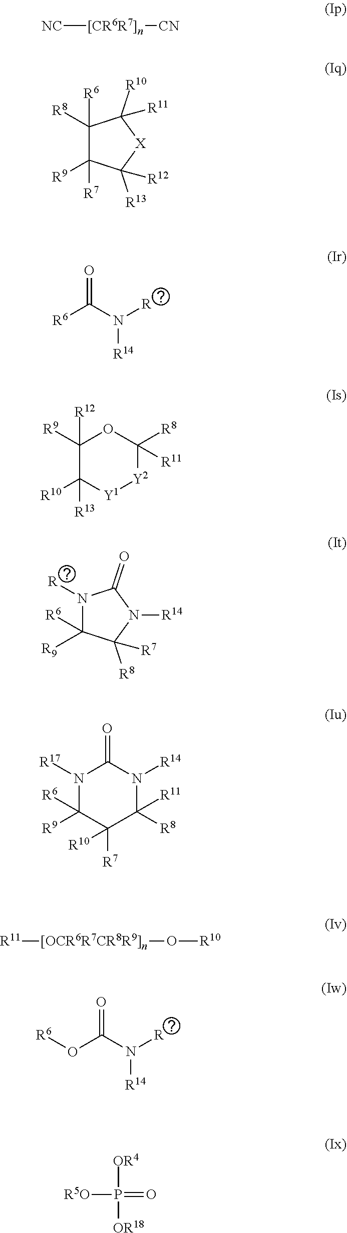

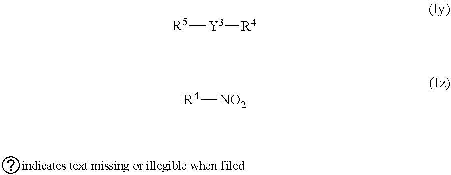

wherein R⁴, R⁵ and R¹⁸ are selected, independently of one another, from the group consisting of C₁-C₁₀ alkyl, C₁-C₅ alkenyl, C₁-C₁₀ perfluoroalkyl and C₆ aryl;
R⁶, R⁷, R⁸, R⁹, R¹⁰, R¹¹, R¹², R¹³, R¹⁵ and R¹⁶ are selected, independently of one another, from the group consisting of H, C₁-C₁₀ alkyl, C₂-C₅ alkenyl, C₁-C₁₀ perfluoroalkyl and C₆ aryl;
n is an integer from 1 to 10, preferably from 1 to 5;
X is O or SO₂;
Y¹ and Y² are selected from O or CR⁶R⁷ with R⁶ and R⁷ as defined above provided that Y₁ and Y₂ are not simultaneously O;
Y³ is SO₂ or S═O;
R¹⁴ and R¹⁷ are selected, independently of one another, from the group consisting of H, C₁-C₅ alkyl, C₂-C₅ alkenyl, and C₆ aryl.

In the present application, the alkyl and alkenyl substituents described in relation to the above solvent formulae are optionally substituted with one or more fluorine atoms, a C₁-C₅ alkoxy group, a C₁-C₁₀ perfluoroalkyl group, a phenyl group, or a CN, OH, NO₂ or SO₂ functional group. In the present application, the C₆ aryl substituent described in relation to the above solvent formulae is optionally substituted with one or more fluorine atoms, a C₁-C₁₀ alkyl group, a C₁-C₅ alkoxy group or a C₁-C₁₀ perfluoroalkyl group. Said solvent may also be a crown ether such as, for example, but not limited to, 18-crown-6 ether, 15-crown-5 ether, 12-crown-4 ether, dibenzo-18-crown-6 ether, dibenzo-24-crown-8 ether, dicyclohexano-18-crown-6 ether, dibenzo-12-crown-4 ether. More preferentially, said solvent is of formula (Ia), (Ib), (Ic), (Id), (Ie), (if), (Ig), (Ih), (Ii), (Ij), (Ik), (Il), (Im), (in), (Io), (Ip), (Iq), (Ir), (is), (it), (Iu), (Iv), (Iw), (Ix), (Iy) or (Iz) wherein R⁴, R⁵ and R¹⁸ are selected, independently of one another, from the group consisting of C₁-C₅ alkyl, C₂-C₃ alkenyl, C₁-C₅ perfluoroalkyl and C₆ aryl;
R⁶, R⁷, R⁸, R⁹, R¹⁰, R¹¹, R¹², R¹³, R¹⁵ and R¹⁶ are selected, independently of one another, from the group consisting of H, C₁-C₅ alkyl, C₁-C₃ alkenyl, C₁-C₅ perfluoroalkyl and C₆ aryl;
n is an integer from 1 to 10, preferably from 1 to 5;
X is O or SO₂;
Y¹ and Y² are selected from O or CR⁶R⁷ with R⁶ and R⁷ as defined above provided that Y₁ and Y² are not simultaneously O;
Y³ is SO₂ or S═O;
R¹⁴ and R¹⁷ are selected, independently of one another, from the group consisting of H, C₁-C₅ alkyl, C₂-C₃ alkenyl, and C₆ aryl.

In particular, said solvent is of formula (Ia), (Ib), (Ic), (Id), (Ie), (If), (Ig), (Ih), (Ii), (Ij), (Ik), (Il), (Im), (In), (Io), (Ip), (Iq), (Ir), (Is), (It), (Iu), (Iv), (Iw), (Ix) or (Iy) wherein R⁴, R⁵ and R¹⁸ are selected, independently of one another, from the group consisting of C₁-C₃ alkyl, C₁-C₃ alkenyl, C₁-C₃ perfluoroalkyl and C₆ aryl;
R⁶, R⁷, R⁸, R⁹, R¹⁰, R¹¹, R¹², R¹³, R¹⁵ and R¹⁶ are selected, independently of one another, from the group consisting of H, C₁-C₃ alkyl, C₂-C₃ alkenyl, C₁-C₃ perfluoroalkyl and C₆ aryl;
n is an integer from 1 to 10, preferably from 1 to 5;
X is O or SO₂;
Y¹ and Y² are selected from O or CR⁶R⁷ with R⁶ and R⁷ as defined above provided that Y₁ and Y₂ are not simultaneously O;
Y³ is SO₂ or S═O;
R¹⁴ and R¹⁷ are selected, independently of one another, from the group consisting of H, C₁-C₃ alkyl, C₂-C₃ alkenyl, and C₆ aryl.

More particularly, said solvent may be of formula (Ia) wherein R⁴ and R⁵ are selected, independently of one another, from the group consisting of CH₃, CH₂F, CHF₂, C₂H₅, CH₂CH₂F, CH₂CHF₂, CH₂CF₃, CH₂CH₂CH₃, CH₂CH₂CH₂F, CH₂CHFCH₃, CH₂CH₂CF₃, CH₂CF₂CHF₂, CF₃, CF₂CF₃, CF₂CF₂CF₃, CH(CF₃)₂, C₆H₅, CH(CH₃)₂, CH₃CH₂CH₂CH₂, (CH₃)₂CHCH₂, CH₃CH₂CH(CH₃), CF₂CF₂CF₂CF₃ and CH(CH₃)₂; preferably, R⁴ is CH₃, C₆H₅, or CH₂CH₃ and R⁵ is selected from the group consisting of CH₃, CH₂F, CHF₂, C₂H₅, CH₂CH₂F, CH₂CHF₂, CH₂CF₃, CH₂CH₂CH₃, CH₂CH₂CH₂F, CH₂CHFCH₃, CH₂CH₂CF₃, CH₂CF₂CHF₂, CF₃, CF₂CF₃, CF₂CF₂CF₃, CH(CF₃)₂, C₆H₅, CF₂CF₂CF₂CF₃ and CH(CH₃)₂.

More particularly, said solvent may be of formula (Ib) wherein R⁶, R⁷, R⁸ and R⁹ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH(CH₃)₂, CH₃CH₂CH₂CH₂, (CH₃)₂CHCH₂, CH₃CH₂CH(CH₃), CH₃CH₂CH₂, CH(CH₃)₂, CH₂CH₃ and CH═CH₂; preferably R⁶, R⁷ and R⁸ are H, CH₃, C₆H₅, or CH₂CH₃ and R⁹ is selected from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃ and CH═CH₂.

More particularly, said solvent may be of formula (Ic) wherein R⁶ and R⁷ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH(CH₃)₂, CH₃CH₂CH₂CH₂, (CH₃)₂CHCH₂, CH₃CH₂CH(CH₃), CH₃CH₂CH₂, CH(CH₃)₂, CH₂CH₃ and CH═CH₂; preferably R⁶ is H, CH₃, C₆H₅ or CH₂CH₃ and R⁷ is selected from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃ and CH═CH₂.

More particularly, said solvent may be of formula (Id) wherein R⁴ and R⁵ are selected, independently of one another, from the group consisting of CH₃, CH₂CH₃, CH₂F, CHF₂, CH₂CH₂F, CH₂CF₃, CH₂OCH₃, CH(CH₃)CH₂OCH₃, CH(CH₃)₂, CF₃, CF₂CF₃, CF₂CF₂CF₃, CH(CF₃)₂, CF₂CF₂CF₂CF₃, C₆H₅, CH(CH₃)₂, CH₃CH₂CH₂CH₂, (CH₃)₂CHCH₂, CH₃CH₂CH(CH₃), CH₃CH₂CH₂, CH(CH₃)₂, CHFCH₃ and CH₂CH₂CH₃; preferably R⁴ is selected from the group consisting of CH₂CH₂F, CH₃, C₆H₅, or CH₂CH₃ and R⁵ is selected from the group consisting of CH₃, CH₂CH₃, CH₂F, CHF₂, CH₂CH₂F, CH₂CF₃, CH₂OCH₃, CH(CH₃)CH₂OCH₃, CH(CH₃)₂, CF₃, CF₂CF₃, CF₂CF₂CF₃, CH(CF₃)₂, CF₂CF₂CF₂CF₃, CHFCH₃ and CH₂CH₂CH₃.

More particularly, said solvent may be of formula (Ie) wherein R⁶, R⁷, R⁸, R⁹, R¹⁰ and R¹¹ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH(CH₃)₂, CH₃CH₂CH₂CH₂, (CH₃)₂CHCH₂, CH₃CH₂CH(CH₃), CH₃CH₂CH₂, CH(CH₃)₂, CH₂CH₃ and CH═CH₂; preferably R⁶, R⁷ and R⁸ are H, CH₃, C₆H₅ or CH₂CH₃ and R⁹, R¹⁰ and R¹¹ are selected, independently of one another, from the group consisting of H, F, CH³, CH²F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃ and CH═CH₂.

More particularly, said solvent may be of formula (if) wherein R⁶, R⁷, R⁸, R⁹, R¹⁰, R¹¹, R¹² and R¹³ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₃CH₂CH₂CH₂, (CH₃)₂CHCH₂, CH₃CH₂CH(CH₃), CH₃CH₂CH₂, CH(CH₃)₂, CH₂CH₃ and CH═CH₂; preferably R⁶, R⁸, R¹⁰ and R¹² are H, CH₃, C₆H₅ or CH₂CH₃ and R⁷, R⁹, R¹¹ and R¹³ are selected, independently of one another, from the group consisting of H, F, CH³, CH²F, CHF², CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃ and CH═CH₂.

More particularly, said solvent may be of formula (Ig) wherein R⁵, R⁷, R⁸, R⁹, R¹⁰ and R¹¹ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH(CH₃)₂, CH₃CH₂CH₂CH₂, (CH₃)₂CHCH₂, CH₃CH₂CH(CH₃), CH₃CH₂CH₂, CH(CH₃)₂, CH₂CH₃ and CH═CH₂; R¹⁴ is H, CH₃, C₅H₅, CH₂CH₃ and CH═CH₂; preferably R⁶, R⁷ and R⁸ are H, CH₃, C₆H₅ or CH₂CH₃ and R⁹, R¹⁰ and R¹¹ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃ and CH═CH₂; and R¹⁴ is H, CH₃, C₆H₅ or CH₂CH₃ and CH═CH₂.

More particularly, said solvent may be of formula (Ih) wherein R⁷, R⁸, R⁹ and R¹¹ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH(CH₃)₂, CH₃CH₂CH₂CH₂, (CH₃)₂CHCH₂, CH₃CH₂CH(CH₃), CH₃CH₂CH₂, CH(CH₃)₂, CH₂CH₃ and CH═CH₂; R¹⁴ is H, CH₃, C₆H₅ or CH₂CH₃ and CH═CH₂; preferably R⁶, R⁷ and R⁸ are H, CH₃, C₆H₅ or CH₂CH₃ and R⁹ and R¹¹ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃ and CH═CH₂; and R¹⁴ is H, CH₃, C₆H₅ or CH₂CH₃ and CH═CH₂.

More particularly, said solvent may be of formula (Ii) wherein R⁶, R⁷, R⁸, R⁹, R¹⁰, R¹¹, R¹² and R¹³ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH(CH₃)₂, CH₃CH₂CH₂CH₂, (CH₃)₂CHCH₂, CH₃CH₂CH(CH₃), CH₃CH₂CH₂, CH(CH₃)₂, CH₂CH₃ and CH═CH₂; R¹¹ is H, CH₃, C₆H₅, or CH₂CH₃ and CH═CH₂; preferably R⁶, R⁸, R¹⁰ and R¹² are H, CH₃, C₆H₅ or CH₂CH₃ and R⁷, R⁹, R¹¹ and R¹³ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃ and CH═CH₂; and R¹⁴ is H, CH₃, C₆H₅ or CH₂CH₃ and CH═CH₂.

More particularly, said solvent may be of formula (Ij) wherein R⁶, R⁷, R⁸ and R⁹ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH(CH₃)₂, CH₃CH₂CH₂CH₂, (CH₃)₂CHCH₂, CH₃CH₂CH(CH₃), CH₃CH₂CH₂, CH(CH₃)₂, CH₂CH₃ and CH═CH₂; preferably R⁶, R⁷ and R⁸ are H, CH₃, C₅H₅, or CH₂CH₃ and R⁹ is selected from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃ and CH═CH₂.

More particularly, said solvent may be of formula (Ik) wherein R⁶, R⁷, R⁸, R⁹, R¹⁰, R¹¹, R¹², R¹³, R¹⁵ and R¹⁶ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH(CH₃)₂, CH₃CH₂CH₂CH₂, (CH₃)₂CHCH₂, CH₃CH₂CH(CH₃), CH₃CH₂CH₂, CH(CH₃)₂, CH₂CH₃ and CH═CH₂; preferably R⁶, R⁷, R⁸, R⁹ and R¹⁰ are H, CH₃, C₆H₅ or CH₂CH₃ and R¹¹, R¹², R¹³, R¹⁵ and R¹⁶ are selected, independently of one another, from the group consisting of H, F, CH³, CH²F, CHF², CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃ and CH═CH₂.

More particularly, said solvent may be of formula (Il) wherein R⁶, R⁷, R⁸, R⁹, R¹⁰, R¹¹, R¹², R¹³, R¹⁵ and R¹⁶ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH(CH₃)₂, CH₃CH₂CH₂CH₂, (CH₃)₂CHCH₂, CH₄₃CH₂CH(CH₃), CH₃CH₂CH₂, CH(CH₃)₂, CH₂CH₃ and CH═CH₂; R¹⁴ is H, CH₃, C₆H₅, or CH₂CH₃ and CH═CH₂; preferably R⁶, R⁷, R⁸, R⁹ and R¹⁰ are H, CH₃, C₆H₅ or CH₂CH₃ and R¹¹, R¹², R¹³, R¹⁵ and R¹⁶ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃ and CH═CH₂; and R¹⁴ is H, CH₃, C₆H₅ or CH₂CH₃ and CH═CH₂.

More particularly, said solvent may be of formula (Im) wherein R⁴ and R⁵ are selected, independently of one another, from the group consisting of CH₃, CH₂CH₃, CH₂F, CHF₂, CH₂CH₂F, CH₂CHF₂, CH₂CF₃, CH₂OCH₃, CH(CH₃)CH₂OCH₃, CH(CH₃)₂, CF₃, CF₂CF₃, CF₂CF₂CF₃, CH(CF₃)₂, CF₂CF₂CF₂CF₃, C₆H₅, CH₃CH₂CH₂CH₂, (CH₃)₂CHCH₂, CH₃CH₂CH(CH₃), CHFCH₃ and CH₂CH₂CH₃; preferably, R⁴ is selected from the group consisting of CH₃, CH₂CH₃, CH₂F, CHF₂, CH₂CH₂F, CH₂CHF₂, CH₂CF₃, CH₂OCH₃, CH(CH₃)CH₂OCH₃, CH(CH₃)₂, CF₃, CF₂CF₃, CF₂CF₂CF₃, CH(CF₃)₂, CF₂CF₂CF₂CF₃, C₆H₅, CHFCH₃ and CH₂CH₂CH₃ and R⁵ is selected from the group consisting of CH₂F, CHF₂, CH₂CH₂F, CH₂CHF₂, CH₂CF₃, CH₂OCH₃, CH(CH₃)CH₂OCH₃, CH(CH₃)₂, CF₃, CF₂CF₃, CF₂CF₂CF₃, CH(CF₃)₂, C₆H₅, CF₂CF₂CF₂CF₃ and CHFCH₃; R⁶, R⁷, R⁸ and R⁹ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃ and CH═CH₂.

More particularly, said solvent may be of formula (In) wherein R⁴ and R⁵ are selected, independently of one another, from the group consisting of CH₃, CH₂CH₃, CH₂F, CHF₂, CH₂CH₂F, CH₂CHF₂, CH(CH₃)₂, CF₃CH₂, CF₃, CF₂CF₃, CF₂CF₂CF₃, CH(CF₃)₂, CF₂CF₂CF₂CF₃, C₆H₅, CH₃CH₂CH₂CH₂, (CH₃)₂CHCH₂, CH₃CH₂CH(CH₃), CHFCH₃ and CH₂CH₂CH₃; preferably, R⁴ is selected from the group consisting of CH₃, CH₂CH₃, CH₂F, CHF₂, CH₂CH₂F, CH₂CHF₂, CH(CH₃)₂, CF₃CH₂, CF₃, CF₂CF₃, CF₂CF₂CF₃, CH(CF₃)₂, CF₂CF₂CF₂CF₃, C₆H₅, CHFCH₃ and CH₂CH₂CH₃; and R⁵ is selected from the group consisting of CH₂F, CHF₂, CH₂CH₂F, CH₂CHF₂, CF₃CH₂, CF₃, CF₂CF₃, CF₂CF₂CF₃, CH(CF₃)₂, C₆H₅, CF₂CF₂CF₂CF₃ and CHFCH₃. More particularly, said solvent may be of formula (Io) wherein R⁴ is selected from the group consisting of CH₃, CH₂CH₃, CH₃OCH₂CH₂, CH₃CH₂CH₂, CH(CH₃)₂, CH₃CH₂CH₂CH₂, (CH₃)₂CHCH₂, CH₃CH₂CH(CH₃), C₆H₅, CF₃—C₆H₄, CH₂F, CHF₂, CH₂CH₂F, CH₂CHF₂, CH(CH₃)₂, CF₃CH₂, CF₃, CF₂CF₃, CF₂CF₂CF₃, CH(CF₃)₂, CF₂CF₂CF₂CF₃, CHFCH₃ and CH₂CH₂CH₃.

More particularly, said solvent may be of formula (Ip) wherein R⁶ and R⁷ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃, CH₃CH₂CH₂, CH(CH₃)₂, CH₃CH₂CH₂CH₂, (CH₃)₂CHCH₂, CH₃CH₂CH(CH₃) and CH═CH₂; preferably, R⁶ and R⁷ are selected, independently of one another, from the group consisting of H, F, CH₃, CH₂CF₃, CF₃, CF₂CF₃, CF₂CF₂CF₃, CH(CF₃)₂, C₆H₅, CH₂CH₃, CH₃CH₂CH₂, CH(CH₃)₂ and CH═CH₂; and n is an integer from 1 to 10, preferably from 1 to 5.

More particularly, said solvent may be of formula (Iq) wherein R⁶, R⁷, R⁸, R⁹, R¹⁰, R¹¹, R¹² and R¹³ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃, CH₃CH₂CH₂, CH(CH₃)₂, CH₃CH₂CH₂CH₂, (CH₃)₂CHCH₂, CH₃CH₂CH(CH₃) and CH═CH₂; and X is O or SO₂; preferably R⁶, R⁷, R⁸, R⁹, R¹⁰, R¹¹, R¹² and R³ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, C₆H₅, CH₂CH₃, CH₃CH₂CH₂, CH(CH₃)₂ and CH═CH₂; and X is O or SO₂.

More particularly, said solvent may be of formula (Ir) wherein R⁵ is selected from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH(CH₃)₂, CH₃CH₂CH₂CH₂, (CH₃)₂CHCH₂, CH₃CH₂CH(CH₃), CH₃CH₂CH₂, CH(CH₃)₂, CH₂CH₃ and CH═CH₂; R¹⁴ and R¹⁷ are selected, independently of one another, from the group consisting of H, CH₃, C₆H₅, CH₂CH₃ and CH═CH₂; preferably R⁶ is H, F, CH₃, CH₂F, CHF₂, CH₂CH₂F, CH₂CHF₂, CH₂CF₃, CF₃, CF₂CF₃, CF₂CF₂CF₃, CH(CF₃)₂, C₆H₅, CH(CH₃)₂, CH₃CH₂CH₂, CH(CH₃)₂, CH₂CH₃ and CH═CH; and R¹⁴ and R¹⁷ are selected, independently of one another, from the group consisting of H, CH₃, C₆H₅, or CH₂CH₃ and CH═CH₂.

More particularly, said solvent may be of formula (Is) wherein R⁸, R⁹, R¹⁰, R¹¹, R¹² and R¹³ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₃CH₂CH₂CH₂, (CH₃)₂CHCH₂, CH₃CH₂CH(CH₃), CH₃CH₂CH₂, CH(CH₃)₂, CH₂CH₃ and CH═CH₂; preferably R⁸, R¹⁰ and R¹² are H, CH₃, C₆H₅ or CH₂CH₃ and R⁹, R¹¹ and R¹³ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃ and CH═CH₂; and Y¹ and Y² are selected from O or CR⁶R⁷ provided that Y¹ and Y² are not simultaneously O, with R⁶ and R⁷ selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₃CH₂CH₂CH₂, (CH₃)₂CHCH₂, CH₃CH₂CH(CH₃), CH₃CH₂CH₂, CH(CH₃)₂, CH₂CH₃ and CH═CH₂; preferably H, CH₃, C₆H₅ or CH₂CH₃.

More particularly, said solvent may be of formula (It) wherein R⁶, R⁷, R⁸ and R⁹ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH(CH₃)₂, CH₃CH₂CH₂CH₂, (CH₃)₂CHCH₂, CH₃CH₂CH(CH₃), CH₃CH₂CH₂, CH(CH₃)₂, CH₂CH₃ and CH═CH₂; R¹⁴ and R¹⁷ are selected, independently of one another, from the group consisting of H, CH₃, C₆H₅, or CH₂CH₃ and CH═CH₂; preferably R⁶ and R⁸ are, independently of one another, H, CH₃, C₆H₅, or CH₂CH₃ and R⁷, R⁹ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃ and CH═CH₂; and R¹⁴ and R¹⁷ are selected, independently of one another, from the group consisting of H, CH₃, C₆H₅, or CH₂CH₃ and CH═CH₂.

More particularly, said solvent may be of formula (Iu) wherein R⁶, R⁷, R⁸, R⁹, R¹⁰ and R¹¹ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH(CH₃)₂, CH₃CH₂CH₂CH₂, (CH₃)₂CHCH₂, CH₃CH₂CH(CH₃), CH₃CH₂CH₂, CH(CH₃)₂, CH₂CH₃ and CH═CH₂; R¹⁴ and R¹⁷ are selected, independently of one another, from the group consisting of H, CH₃, C₆H₅, or CH₂CH₃ and CH═CH₂; preferably R⁶, R⁸ and R¹⁰ are, independently of one another, H, CH₃, C₆H₅, or CH₂CH₃ and R⁷, R⁹, R¹¹ are selected, independently of one another, from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃ and CH═CH₂; and R¹⁴ and R¹⁷ are selected, independently of one another, from the group consisting of H, CH₃, C₆H₅, or CH₂CH₃ and CH═CH₂.

More particularly, said solvent may be of formula (Iv) wherein R⁶, R⁷, R⁸, R⁹, R¹⁰ and R¹¹ are selected, independently of one another from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH₂CH₃, CH₃CH₂CH₂, CH(CH₃)₂, CH₃CH₂CH₂CH₂, (CH₃)₂CHCH₂, CH₃CH₂CH(CH₃) and CH═CH₂; preferably R⁶, R⁷, R⁸ and R⁹ are selected, independently of one another, from the group consisting of H, F, CH₃, CH₂CF₃, CF₃, CF₂CF₃, CF₂CF₂CF₃, CH(CF₃)₂, C₆H₅, CH₂CH₃, CH₃CH₂CH₂, CH(CH₃)₂, and CH═CH₂; and n is an integer from 1 to 10, preferably from 1 to 5.

More particularly, said solvent may be of formula (Iw) wherein R⁶ is selected from the group consisting of H, F, CH₃, CH₂F, CHF₂, CH₂CH₂F, CH₂CHF₂, CH₂CF₃, CF₃, CF₂CF₃, CF₂CF₂CF₃, CH(CF₃)₂, CF₂CF₂CF₂CF₃, C₆H₅, CH(CH₃)₂, CH₃CH₂CH₂CH₂, (CH₃)₂CHCH₂, CH₃CH₂CH(CH₃), CH₃CH₂CH₂, CH(CH₃)₂, CH₂CH₃ and CH═CH₂; R¹⁴ and R¹⁷ are selected, independently of one another, from the group consisting of H, CH₃, C₆H₅, CH₂CH₃ and CH═CH₂; preferably R⁶ is H, F, CH₃, CH₂F, CHF₂, CH₂CH₂F, CH₂CHF₂, CH₂CF₃, CF₃, CF₂CF₃, CF₂CF₂CF₃, CH(CF₃)₂, C₆H₅, CH(CH₃)₂, CH₃CH₂CH₂, CH(CH₃)₂, CH₂CH₃ and CH═CH; and R¹⁴ and R¹⁷ are selected, independently of one another, from the group consisting of H, CH₃, C₆H₅, or CH₂CH₃ and CH═CH₂.

More particularly, said solvent may be of formula (Ix) wherein R⁴, R⁵ and R¹⁸ are selected, independently of one another, from the group consisting of CH₃, CH₂F, CHF₂, C₂H₅, CH₂CH₂F, CH₂CHF₂, CH₂CF₃, CH₂CH₂CH₃, CH₂CH₂CH₂F, CH₂CHFCH₃, CH₂CH₂CF₃, CH₂CF₂CHF₂, CF₃, CF₂CF₃, CF₂CF₂CF₃, CH(CF₃)₂, C₆H₅, CH(CH₃)₂, CH₃CH₂CH₂CH₂, (CH₃)₂CHCH₂, CH₃CH₂CH(CH₃), CF₂CF₂CF₂CF₃ and CH(CH₃)₂.

More particularly, said solvent may be of formula (Iy) wherein R⁴ and R⁵ are selected, independently of one another, from the group consisting of CH₃, CH₂F, CHF₂, C₂H₅, CH₂CH₂F, CH₂CHF₂, CH₂CF₃, CH₂CH₂CH₃, CH₂CH₂CH₂F, CH₂CHFCH₃, CH₂CH₂CF₃, CH₂CF₂CHF₂, CF₃, CF₂CF₃, CF₂CF₂CF₃, CH(CF₃)₂, C₆H₅, CH(CH₃)₂, CH₃CH₂CH₂CH₂, (CH₃)₂CHCH₂, CH₃CH₂CH(CH₃), CF₂CF₂CF₂CF₃ and CH(CH₃)₂; Y³ is SO₂ or S═O.

More particularly, said solvent may be of formula (Iz) wherein R⁴ is selected from the group consisting of CH₃, CH₂F, CHF₂, C₂H₅, CH₂CH₂F, CH₂CHF₂, CH₂CF₃, CH₂CH₂CH₃, CH₂CH₂CH₂F, CH₂CHFCH₃, CH₂CH₂CF₃, CH₂CF₂CHF₂, CF₃, CF₂CF₃, CF₂CF₂CF₃, CH(CF₃)₂, C₆H₅, CH(CH₃)₂, CH₃CH₂CH₂CH₂, (CH₃)₂CHCH₂, CH₃CH₂CH(CH₃), CF₂CF₂CF₂CF₃ and CH(CH₃)₂.

In a nonlimiting manner, said solvent is for example selected from the group consisting of propylene carbonate, ethylene carbonate, butylene carbonate, dimethyl carbonate, diethyl carbonate, dimethoxyethane, gamma-butyrolactone, 3-fluoro-gamma-butyrolactone, delta-valerolactone, gamma-valerolactone, epsilon-caprolactone, gamma-caprolactone, butyrolactam, valerolactam, N-methyl-butyrolactam, N-methyl-valerolactam, fluoroethylene carbonate, fluoropropylene carbonate, monofluoromethyl methyl carbonate, methyl-2,2,2-trifluoroethyl carbonate, trifluoroethyl ethyl carbonate, bis(2,2,2-trifluoroethyl carbonate), propyl-2,2,2-trifluoroethyl carbonate, methylnonafluorobutyl ether, hexafluoroisopropyl methyl ether, bis(2,2,2-trifluoroethyl)ether, methyl nonafluorobutyl ether, ethyl nonafluorobutyl ether, methyl isopropyl carbonate, ethyl isopropyl carbonate, propyl ethyl carbonate, methyl propyl carbonate, 1-fluoropropyl methyl carbonate, 2-fluoropropyl methyl carbonate, 1,1,1-trifluoropropyl methyl carbonate, 1,1,1,2,2-pentafluoropropyl methyl carbonate, 1,1,2,2-tetrafluoropropyl methyl carbonate, 1,1,1-trifluoroethyl methyl carbonate, 1,1-difluoroethyl methyl carbonate, 1-fluoroethyl methyl carbonate, ethyl methyl carbonate, dimethyl carbonate, diethyl carbonate, methyl fluoromethyl carbonate, 1-fluoroethyl ethyl carbonate, 1,1-difluoroethyl ethyl carbonate, 1,1,1-trifluoroethyl ethyl carbonate, vinyl ethylene carbonate, vinylene carbonate, ethyl ethanoate, ethyl 1-fluoroethanoate, ethyl 1,1-difluoroethanoate, 1-fluoroethyl ethanoate, methyl ethanoate, 1-methoxy isopropyl ethanoate, 1-fluoroethyl propanoate, ethyl 2-fluoropropanoate, methyl butanoate, ethyl butanoate, methyl methoxyethanoate, N-methyl-2-oxazolidinone, ethylene glycol diethyl ether, tetrahydrofuran, 2-methyltetrahydrofuran, 2,6-dimethyltetrahydrofuran, tetrahydropyran, triethylene glycol dimethyl ether, tetraethylene glycol dimethyl ether, 1,4-dioxane, 1,3-dioxolane, dimethyl carbonate, ethyl methyl carbonate, diethyl carbonate, diphenyl carbonate, methyl phenyl carbonate, ethylene 2.3-dimethylcarbonate, vinylene carbonate, ethylene 2-vinylcarbonate, methyl benzoate, ethyl benzoate, 5-valerolactone, trimethyl phosphate, ethyl dimethyl phosphate, diethyl methyl phosphate, triethyl phosphate, acetonitrile, propionitrile, methoxypropionitrile, glutaronitrile, adiponitrile, 2-methylglutaronitrile, valeronitrile, butyronitrile, isobutyronitrile, N-methylformamide, N-ethylformamide, N,N-dimethylformamide, N,N-dimethylacetamide, N-methylpyrrolidinone, N-methylpyrrolidone, N-vinylpyrrolidone, dimethylsulfone, ethylmethylsulfone, diethylsulfone, sulfolane, 3-methylsulfolane, 2.4-dimethylsulfolane, ethylene glycol, propylene glycol, ethylene glycol monomethyl ether, ethylene glycol monoethyl ether, dimethyl sulfoxide, methyl ethyl sulfoxide, diethyl sulfoxide, benzonitrile, tolunitrile, 1,3-dimethyl-2-imidazolidinone, 1,3-dimethyl-3,4,5,6-tetrahydro-2(1,H)-pyrimidinone, 3-methyl-2-oxazolidinone, nitromethane, nitroethane, nitropropane, nitrobutane. These solvents may be used alone or in combination.

Alternatively, said solvent may be an ionic liquid. Preferably, the ionic liquid is of formula (cation)FSI or (cation)TFSI where FSI is bis(fluorosulfonyl)imide and TFSI is bis(trifluoromethanesulfonyl)imide. Preferably, the cation is of ammonium, imidazolium, pyrrolidinium, piperidinium, phosphonium, sulfonium or oxonium type. In a nonlimiting manner, mention may be made of (1-ethyl-3-methylimidazolium bis(fluorosulfonyl)imide), (1-butyl-3-methylimidazolium bis(fluorosulfonyl)imide), (1-butyl-1-methylpyrrolidinium bis(fluorosulfonyl)imide), (1-propyl-3-methylpyrrolidinium bis(fluorosulfonyl)imide), (1-butyl-1-methylpiperidinium bis(fluorosulfonyl)imide), (1-Methyl-1-propylpiperidinium bis(fluorosulfonyl)imide), (methyl(tri-n-butyl)phosphonium bis(fluorosulfonyl)imide), (methyl(tri-n-ethyl)phosphonium bis(fluorosulfoyl)imide), (1-ethyl-3-methylimidazolium bis(trifluoromethanesulfonyl)imide), (1-butyl-3-methylimidazolium bis(trifluoromethanesulfonyl)imide), (1-butyl-1-methylpyrrolidinium bis(trifluoromethanesulfonyl)imide), (1-propyl-3-methylpyrrolidinium bis(trifluoromethanesulfonyl)imide), (1-butyl-1-methylpiperidinium bis(trifluoromethanesulfonyl)imide), (1-methyl-1-propylpiperidinium bis(trifluoromethanesulfonyl)imide), (methyl(tri-n-butyl)phosphonium bis(trifluoromethanesulfonyl)imide) (methyl(tri-n-ethyl)phosphonium bis(trifluoromethanesulfonyl)imide).

Alternatively, said solvent used in the present electrolyte composition has a dipole moment greater than 2 Debye at 25° C. Preferably, said solvent has a dipole moment greater than 2.5 Debye, preferably greater than 3.0 Debye, more preferentially greater than 3.5 Debye, in particular greater than 4.0 Debye at 25° C.

For example, in a nonlimiting manner, said electrolyte may be selected from the group consisting of propylene carbonate, 1-fluoroethyl methyl carbonate, 1-fluoroethyl ethyl carbonate, 1,1-difluoroethyl methyl carbonate, 1,1-difluoroethyl ethyl carbonate, 1,1,1-trifluoroethyl methyl carbonate, 1,1,1-trifluoroethyl ethyl carbonate, perfluoroethyl methyl carbonate, perfluoroethyl ethyl carbonate, propyl methyl carbonate, propyl ethyl carbonate, dimethoxymethane, ethylene carbonate, isopropyl methyl carbonate, isopropyl ethyl carbonate, fluoroethylene carbonate, vinylidene carbonate, butylene carbonate, vinyl ethylene carbonate, fluoropropylene carbonate, fluoro-gamma-butyrolactone, delta-valerolactone, gamma-butyrolactone, fluoropropyl methyl carbonate, 2-fluoropropyl methyl carbonate, 1,1,1-trifluoropropyl methyl carbonate, 1,1,2,2-tetrafluoropropyl methyl carbonate, 1,1,1,2,2-pentafluoropropyl methyl carbonate, fluoropropyl ethyl carbonate, 2-fluoropropyl ethyl carbonate, 1,1,1-trifluoropropyl ethyl carbonate, 1,1,2,2-tetrafluoropropyl ethyl carbonate, 1,1,1,2,2-pentafluoropropyl ethyl carbonate, nitromethane, 18-crown-6 ether, 15-crown-5 ether, 12-crown-4 ether, dibenzo-18-crown-6 ether, dibenzo-24-crown-8 ether, dicyclohexano-18-crown-6 ether, dibenzo-12-crown-4 ether, nitromethane, nitroethane, nitropropane, nitrobutane, trimethyl phosphate, ethyl dimethyl phosphate, diethyl methyl phosphate, triethyl phosphate, acetonitrile, propionitrile, methoxypropionitrile, glutaronitrile, adiponitrile, 2-methylglutaronitrile, valeronitrile, butyronitrile, isobutyronitrile, N-methylformamide, N-ethylformamide, N,N-dimethylformamide, N,N-dimethylacetamide, N-methylpyrrolidinone, N-methylpyrrolidone, N-vinylpyrrolidone, dimethylsulfone, ethylmethylsulfone, diethylsulfone, sulfolane, 3-methylsulfolane, 2,4-dimethylsulfolane, dimethyl sulfoxide, methyl ethyl sulfoxide, diethyl sulfoxide, benzonitrile, tolunitrile, 1,3-dimethyl-2-imidazolidinone, 3-methyl-2-oxazolidinone.

As mentioned above, said electrolyte composition also comprises a lithium salt. For example, the lithium salt may be LiPF₆, LiOSO₂CF₃, LIN(SO₂CF₃)₂, LIN(SO₂F)₂, LiBF₄, LClO₄, lithium 2-trifluoromethyl-4,5-dicyanoimidazolate, lithium difluorophosphate (LiPO₂F₂), lithium bis(oxalato)borate (LiB(C₂O₄)₂), lithium difluoro(oxalato)borate (LiF₂B(C₂O₄)₂) or LiNO₃.

### EXAMPLES

The following examples illustrate the scope of the invention in a nonlimiting manner.

The examples according to the invention and comparative examples described below were carried out according to the same protocol.

### Preparation of the Latexes:

The 3 different latexes are indicated in table 1 below with their main characteristics: HFP content in the P(VDF-HFP) copolymer, PVDF/acrylic ratio, solids content. The polymer resins used for tests 3 and 4 are according to the present invention. The polymer resins according to the present invention were prepared from a P(VDF-HFP) copolymer latex used as seed for synthesizing the corresponding fluoro-acrylic polymer composition by means of an emulsion polymerization process according to the protocol described in WO 2007/018783.

Preparation of a PVDF/acrylic polymer blend: The P(VDF-HFP) copolymer latex and the acrylic latex with a composition similar to the acrylic part of the polymer resin of test 4 are prepared independently of one another by means of an emulsion polymerization process as indicated above. The two latexes are then mixed in a ratio of 70/30.

### Preparation of the Coating Compositions:

For each of tests 2 to 4, the latex indicated is added to a thickening agent (CMC 250k in solution at 3.5% in water) plus, if necessary, the remainder, in the form of demineralized water, to obtain the same solids content close to 25.4% independently of the initial solids content of the latex alone. Mixing is carried out under moderate shear in a Thinky mixer 200 rpm/10 min. The other additives—wetting agent (BYK 349), adhesion promoter (BYK LPC-22346, already supplied in 50% solution) are then added only for the composition not already containing acrylic in the latex (=test 2)—then mixing is performed again at 200 rpm/10 min.

### Application of the Coatings:

Each coating composition is applied to a porous PE separator (Gelon, thickness 12 micron) with a coater equipped with a spiral bar depositing 6 μm (wet thickness) at a rate of approximately 25 mm/sec, and then dried at ambient temperature for 24 h.

TABLE 1

| | | Test 1 | Test 2 | Test 3 | Test 4 |
|---|---|---|---|---|---|
| Latex | HFP wt % in PVDF | — | 4.5 | 23 | 6.5 |
| | PVDF/Acrylic (wt) | — | 100/0 | 50/50 | 70/30 |
| | Solids content | — | 30 | 46 | 34 |
| | (wt %) | | | | |
| Coating | Water | — | 0 | 29 | 10.2 |
| composition | Thickener | — | 11.6 | 11.6 | 11.6 |
| | Latex | — | 83.4 | 54.4 | 73.2 |
| | TOTAL | — | 95 | 95 | 95 |
| | Solids content | — | 25.4 | 25.4 | 25.3 |
| | (wt %) | | | | |
| | Wetting agent | — | 0.5 | 0.5 | 0.5 |
| | Adhesion promoter | — | 4.5 | 0 | 0 |

### Wettability Test

A drop of 2 ml of the electrolyte composition is deposited on the separator. A visual inspection makes it possible to confirm whether good wettability is observed, that is to say whether the electrolyte composition impregnates the separator, or on the contrary whether no wettability is observed, that is to say that the drop of the electrolyte composition does not impregnate the separator. Visual inspection is performed after 30 minutes for all samples. Very good wettability is scored 2, good wettability is scored 1, and an absence of wettability is scored 0.

The electrolyte composition is prepared by mixing the solvent and lithium salt in question in amounts calculated to achieve the desired concentration. In the examples below, the lithium salt concentration is 4 mol·l⁻¹ for the two solvents considered, i.e. propylene carbonate (PC) and diethyl carbonate (DEC).

Test 1 is carried out in the presence of a separator made solely of a polyethylene support, without coating. Test 2 is carried out in the presence of a separator comprising a polyethylene support coated with a PVDF film without an acrylic part. Test 3 and test 4 are carried out in the presence of a separator comprising a polyethylene support coated with a fluoro-acrylic polymer latex (prepared by emulsion as indicated above). The results are presented in table 2 below.

TABLE 2

| Electrolyte | | | | | | |
|---|---|---|---|---|---|---|
| composition | η (cP) | μ | Test 1 | Test 2 | Test 3 | Test 4 |
| 4M LiFSI | 120 | 4.9 D | 0 | 0 | 1 | 2 |
| in PC | | | | | | |
| 4M LiFSI | 38 | 1.07 D | 0 | — | 1 | 2 |
| in DEC | | | | | | |

μ: Dipole moment in Debye; η: viscosity measured at 20° C. at a shear of 20 s⁻¹ with a Brookfield Metek DV2T viscometer; PC: Propylene carbonate; DEC: Diethyl carbonate.

As shown by the above results, the polymer resins according to the present invention (test 3 and test 4) impregnate the separator more easily than a polymer resin without an acrylic component.

1. An electrochemical device comprising a separator and an electrolyte composition, characterized in that:
i) said separator comprises at least one coating comprising a polymer resin comprising monomer units of vinylidene fluoride and monomer units of formula R¹R²C═C(R³)C(O)R wherein the substituents R¹, R² and R³ are selected, independently of one another, from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl optionally substituted with one or more —OH groups or a five- or six-membered heterocycle comprising at least one nitrogen atom in its cyclic chain, and
ii) said electrolyte composition comprises a solvent and a lithium salt; said electrolyte composition having a viscosity greater than 2 cP measured at 20° C. and with a shear of 20 s⁻¹ or said solvent having a dipole moment greater than 2 Debye at 25° C.

2. The electrochemical device of claim 1, wherein said electrolyte composition has a viscosity greater than 5 cP, measured at 20° C. and with a shear of 20 s⁻¹.

3. The electrochemical device of claim 1, wherein said solvent has a dipole moment greater than 2.5 Debye at 25° C.

4. The electrochemical device of claim 1, wherein said polymer resin is a copolymer comprising monomer units of vinylidene fluoride and monomer units of formula R¹R²C═C(R³)C(O)R or said polymer resin is a mixture of a fluoropolymer comprising monomer units of vinylidene fluoride and an acrylic polymer comprising monomer units of formula R¹R²C═C(R³)C(O)R wherein the substituents R¹, R² and R³ are selected, independently of one another, from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl optionally substituted with one or more —OH groups or a five- or six-membered heterocycle comprising at least one nitrogen atom in its cyclic chain.

5. The electrochemical device of claim 1, wherein said polymer resin is a mixture of a fluoropolymer comprising monomer units of vinylidene fluoride and an acrylic polymer comprising monomer units of formula R¹R²C═C(R³)C(O)R wherein the substituents R¹, R² and R³ are selected, independently of one another, from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl optionally substituted with one or more —OH groups or a five- or six-membered heterocycle comprising at least one nitrogen atom in its cyclic chain; and said fluoropolymer is selected from the group of polyvinylidene fluoride homopolymers and copolymers based on polyvinylidene fluoride and on at least one comonomer compatible with vinylidene fluoride.

6. The electrochemical device of claim 5, wherein said comonomers are selected from the group consisting of vinyl fluoride, tetrafluoroethylene, hexafluoropropylene, trifluoropropenes, tetrafluoropropenes, hexafluoroisobutylene, perfluorobutylethylene, pentafluoropropenes, perfluoroalkyl vinyl ethers, bromotrifluoroethylene, chlorofluoroethylene, chlorotrifluoroethylene, chlorotrifluoropropene and ethylene.

7. The electrochemical device of claim 5, wherein said fluoropolymer is a polyvinylidene fluoride-hexafluoropropylene copolymer having a percentage by weight of hexafluoropropylene monomer units of from 2% to 25% by weight relative to the weight of the copolymer.

8. The electrochemical device of claim 5, wherein said fluoropolymer comprises monomer units bearing at least one of the following functions: carboxylic acid, carboxylic acid anhydride, carboxylic acid esters, epoxy groups, amide, hydroxyl, carbonyl, mercapto, sulfide, oxazoline, phenolic, ester, ether, siloxane, sulfonic, sulfuric, phosphoric or phosphonic.

9. The electrochemical device of claim 5, wherein said acrylic polymer contains a monomer selected from the group consisting of methyl acrylate, ethyl acrylate, propyl acrylate, n-butyl acrylate, isobutyl acrylate, t-butyl acrylate, n-dodecyl acrylate, amyl acrylate, isoamyl acrylate, hexyl acrylate, 2-ethylhexyl acrylate, diacetone acrylamide, lauryl acrylate, n-octyl acrylate, hydroxybutyl acrylate, hydroxypropyl methacrylate, methyl acrylic acid, methyl methacrylate, ureido methacrylate and combinations thereof.

10. The electrochemical device of claim 1, wherein said coating comprises inorganic particles selected from the group consisting of: BaTiO₃, Pb(Zr,Ti)O₃, Pb₁₋ₓLaₓZr_{y}O₃ (0<x<1, 0<y<1), PbMg₃Nb_{2/3}O₃, PbTiO₃, hafnia (HfO (HfO₂), SrTiO₃, SnO₂, CeO₂, MgO, NiO, CaO, ZnO, Y₂O₃, boehmite (γ-AlO(OH)), Al₂O₃, TiO₂, SiC, ZrO₂, boron silicate, BaSO₄, nanoclays, or mixtures thereof.

11. The electrochemical device of claim 1, wherein said device is selected from the group consisting of a Li-ion battery, a capacitor, an electric double layer capacitor, and a membrane electrode assembly (MEA) for a fuel cell; preferably the Li-ion battery.

12. The electrochemical device of claim 1, wherein said device is a Li-ion secondary battery and also comprises an anode and a cathode.

13. The electrochemical device of claim 1, wherein said electrolyte composition has a viscosity greater than 15 cP.

14. The electrochemical device of claim 1, wherein said solvent has a dipole moment greater than 3.5 debye.
